(19) United States
(12) Patent Application Publication
(10) Pub. No.: US 2011/0160914 A1
(43) Pub. Date: Jun. 30, 2011

(54) TILT SENSOR APPARATUS AND METHOD

(75) Inventor: Robert H. Kennett, Bedford, NH (US)

(73) Assignee: SEQUEST SYSTEMS CORP, Bedford, NH (US)

(21) Appl. No.: 12/963,294

(22) Filed: Dec. 8, 2010

Related U.S. Application Data
(60) Provisional application No. 61/267,551, filed on Dec. 8, 2009.

(51) Int. Cl. G05B 13/00

(52) U.S. Cl. 700/276

(57) ABSTRACT

A tilt sensor apparatus and method provide sensing and feedback of angular orientation. In preferred embodiments, the tilt sensor apparatus and method of the present disclosure may advantageously be used in an HVAC system to provide feedback on damper position to an HVAC controller.

### CROSS-REFERENCE TO RELATED APPLICATION

This application claims the benefit of priority under 35 U.S.C. §119(e) based on U.S. Provisional Application Ser. No. 61/267,551 filed Dec. 8, 2009. The aforementioned provisional application is incorporated herein by reference in its entirety.

### BACKGROUND

The present disclosure relates to a tilt sensor and, more particularly, to an apparatus and method for monitoring angular orientation or position and providing feedback on orientation or position to a central controller. The present disclosure finds particular utility in sensing and controlling the angular orientation of a rotatable damper in a Heating, Ventilation & Air Conditioning (HVAC) system and will be described herein primarily by way of reference thereto. However, it will be recognized that the tilt sensor device of the present disclosure may be employed with other applications where the measurement of an arc is required, including, a wide variety of valves, float switches, security monitoring devices, and others.

A damper is a device rotatably mounted in an air duct for regulating the flow of air through the duct. Commonly, a damper employs one or more vanes that rotate on a shaft, such that when the vane(s) are rotated parallel to the air flow, air will pass unimpeded; and when the vanes are rotated to a closed position the damper allows little or no air to pass. The damper may also set the vane or vanes to some intermediate position to partially restrict air flow. An HVAC system may employ a plurality of dampers which can be selectively controlled to distribute air effectively throughout a building or facility.

Complex HVAC controllers need to know what position these dampers are in, and thus how much air is being directed through a particular duct. A switch or sensor is usually mounted to a damper shaft to send vane position data back to the HVAC controller. The HVAC controller can then use the sensed data position to control or adjust damper position, for example, to more accurately adjust vane position for better efficiency, use the data as a fault indication if the damper malfunctions, and so forth.

The switches and sensors commonly used to determine damper position suffer from several limitations, including use of hazardous materials, limited life, and difficulty of operation. For example, such devices are known to use mercury-filled switches to sense damper position, which have several undesirable attributes. For example, mercury filled switches can only indicate on/off position and the on/off trip point is fixed. In addition, mercury is an extremely hazardous substance.

They are also known to employ a potentiometer or rheostat to sense damper position in HVAC systems. However, these also have undesirable attributes, including limited service life due to mechanical wear, susceptibility to contamination by dirt, moisture or other contaminants, the need for calibration and maintenance to compensate for premise wiring, and the mechanically fixed range of travel of such devices.

Accordingly, the present disclosure contemplates a new and improved apparatus and method for sensing and controlling damper position employing a solid-state accelerometer having no moving parts.

### SUMMARY

In one aspect, an apparatus is provided for use in an HVAC system for measuring the position of a damper which is rotatable about a pivot axis to selectively resist air flow in the HVAC system. The apparatus includes an accelerometer for generating acceleration data representative of an angular orientation of the accelerometer and a signal processor which provides a position signal representative of the position of the damper in response to the acceleration data. The apparatus further includes a control interface that is operable to output a control signal in response to the position signal to an HVAC controller.

In a further aspect, a method for determining the position of a damper in an HVAC system includes providing an accelerometer, disposing the accelerometer on the damper, generating acceleration data with the accelerometer, the acceleration data representative of the angular orientation of the accelerometer, creating a position signal in response to the acceleration data, the position signal representative of the position of the damper, and processing the position signal to produce a control signal indicative of the position of the damper.

### BRIEF DESCRIPTION OF THE DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention.

FIG. 1 is an isometric view of an exemplary tilt sensor in accordance with the present disclosure.

FIGS. 2A, 2B, and 2C illustrate an exemplary HVAC damper employing the tilt sensor of the present disclosure in closed, fully open, and partially open positions, respectively.

FIG. 3 is a block diagram showing the major components of a tilt sensor device in accordance with an exemplary embodiment of the present invention.

FIG. 4 is an exemplary circuit layout of the tilt sensor device herein.

FIG. 5 is a schematic of the tilt sensor device according to an exemplary embodiment of the present disclosure.

### DETAILED DESCRIPTION OF THE PREFERRED EMBODIMENTS

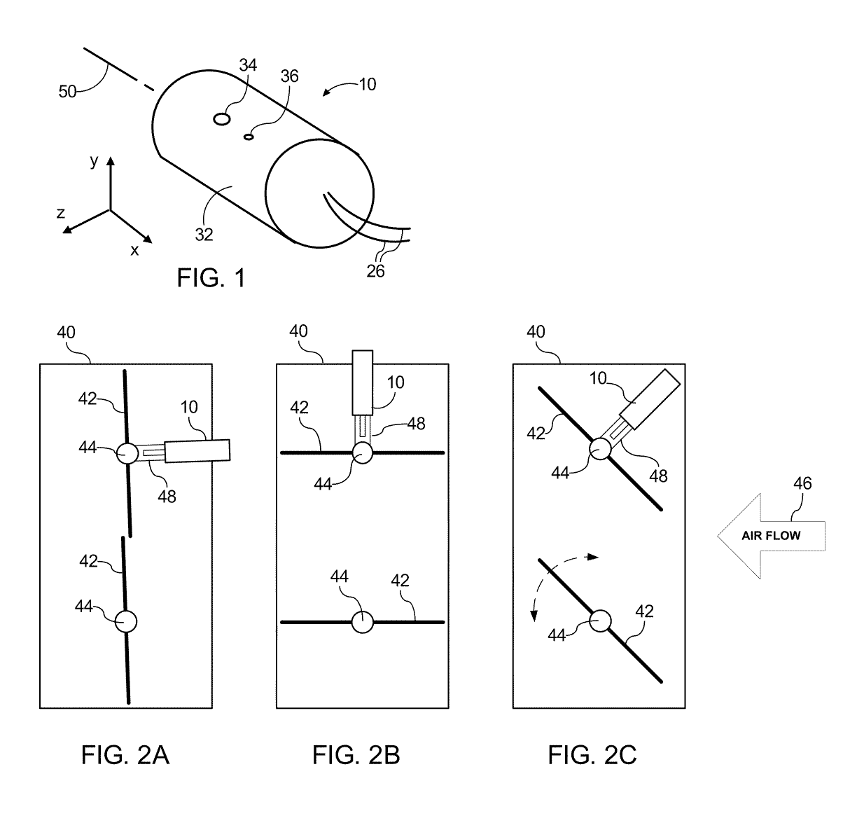

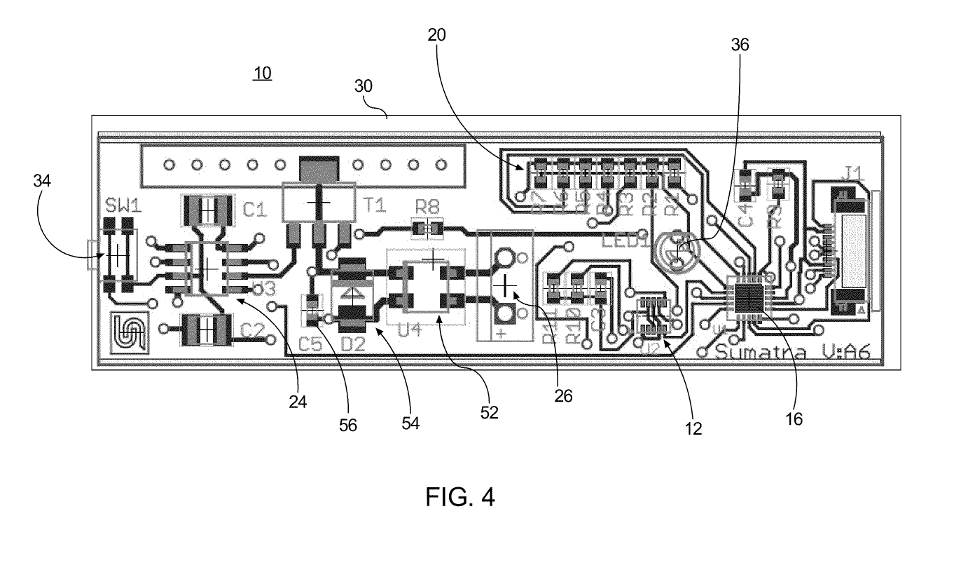

Referring to FIGS. 1, 2A-2C, and 3-5, there is illustrated an exemplary embodiment tilt sensor 10, which includes a circuit board 30 mounted within a housing 32. The circuit board layout appearing in FIG. 4 is exemplary only and other layouts are contemplated. For ease of illustration, only the circuit connections on the top side of the circuit board 30 are shown. Input and output means 34 and 36, respectively, may be provided on the housing 32. Electrical conductors 26 exit through the housing 32 for outputting a control signal, such as a 4-20 milliampere (mA) control signal, to a controller 28 of an HVAC system.

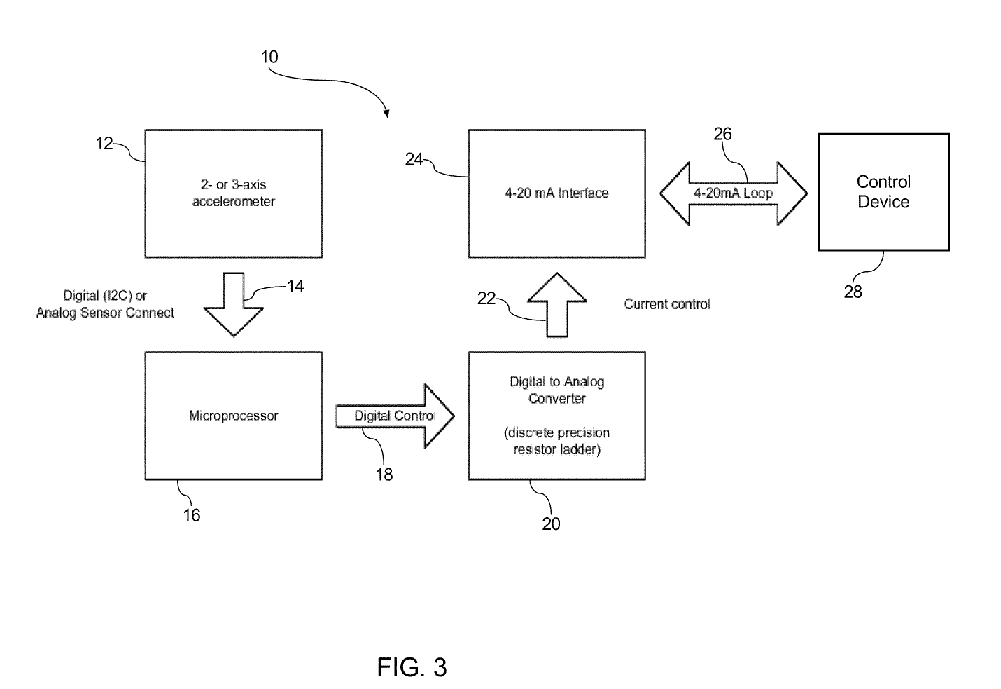

As best seen in FIG. 3, the device 10 in accordance with the depicted preferred embodiment consists of three general sections, namely, a sensor (12), a processor (16), and an output section (20, 24). The sensor portion of the device 10 includes an accelerometer 12, which may be a commercially available accelerometer. The accelerometer 12 measures the orientation of the device 10, and may be an analog or digital, 2-axis or 3-axis accelerometer. For example, in certain embodiments, the accelerometer 12 may be a 2- or 3-axis, analog accelerometer, which outputs a signal 14 for each axis of the accelerometer 12 that is read into the processor 16, e.g., using an internal analog-to-digital converter (ADC) on the processor 16. In an alternative embodiment, a dedicated ADC (not shown) may be employed to create a digital representation of an analog output signal 14, for example, in the case of an analog accelerometer 12 where the processor 16 does not have an on-chip ADC.

In preferred embodiments, a digital accelerometer 12 is used, preferably a three-axis digital accelerometer, which provides several advantages such as improved cost, noise immunity and power operating range. Also, the use of a 3-axis accelerometer 12 is advantageous in that it allows the software to read the correct pitch when the accelerometer is mounted at any arbitrary angle on the damper.

An exemplary HVAC damper 40 is shown in FIGS. 2A-2C, and includes one or more (two in the exemplary embodiment shown) vanes or plates 42 rotatable about a pivot axis or shaft 44. When the vanes 42 are rotated to an orientation perpendicular to the direction of airflow 46 (see FIG. 2A), airflow in the duct is substantially blocked. When the vanes 42 are rotated to a direction parallel to the airflow direction 46 (see FIG. 2B), air is permitted to flow freely through the damper 40. It is also contemplated that in some instances the vanes 42 could be rotated to an intermediate position (see, e.g., FIG. 2C) offering partial resistance to the airflow 46.

In still further embodiments, a magnetometer may be provided in place of the accelerometer 12 to sense the earth's magnetic field in 3 axes. This would be advantageous in sensing rotation about a vertical axis, although accuracy may otherwise decrease.

An output signal 14 representative of the position or orientation of the device 10, which as noted above may be a digital or analog signal, is output by the accelerometer 12 to the processing section, which includes a processor 16. The processor 16 may be a microprocessor, microcontroller, or other device, such as a programmable logic device (PLD), complex programmable logic device (CPLD), field programmable gate array (FPGA), field programmable object array (FPOA), or the like. The processor 16 may be a commercially available processor. In preferred embodiments, the processor 16 may be a PIC18LF13K22 microcontroller available from Microchip Technology Inc. of Chandler, Ariz., which provides ease of use, low cost, and low power consumption. The PIC18LF13K22 processor is a complete, stand-alone system on chip (SOC) and requires no external circuitry.

The device 10 is preferably field-programmable, has a variable trip point, and may be programmed to any range or orientation during installation, with a 4-20 mA output range representing any real-world arc range of damper positions. The device 10 may be designed as a drop-in replacement for mercury switches or other sensors in existing applications or HVAC systems. Alternatively, the device 10 may be adapted for use in new installations. Because the device 10 requires no operator input or power source, it may be completely encapsulated within the housing 32, and thus may be adapted to withstand harsh environments. The current output is not dependent on voltage or premise wiring resistance, and may be configured to compensate for environmental variations during operation.

In operation, a digital signal 18, which is generated based on sensed damper position from the accelerometer output 14, is sent from the processor 16 to the output section 20, 24 for relaying a control signal e.g., a 4-20 mA control signal, to the control device 28. The control device 28 may be, for example, an HVAC controller. In the depicted embodiment, the output section includes the digital-to-analog converter (DAC) 20 and a standard 4-20 mA current loop interface 24 for outputting a 4-20 mA control signal onto the control loop 26.

The DAC 20 receives the digital control signal 18 from the processor 16 and converts the signal 18 to an analog signal 22. In preferred embodiments, the DAC 20 may be a simple resistor ladder. Since the input to the loop controller 24 is a simple current input, and the output pins of the microprocessor can be driven high, low, or tristated, a series resistor on multiple digital output pins with precisely chosen values are summed to drive the current sense input of the loop controller 24. In preferred embodiments, a resistor ladder with six or seven resistors may be employed.

The 4-20 mA current loop interface 24 may be a commercially available current loop controller and may advantageously be a monolithic, commercially available device, such as a Texas Instruments XTR115, available from Texas Instruments Incorporated of Dallas, Tex. The interface 24 receives the current input 22 and regulates the sensor line of the control loop 26 at a percentage of the input current 22, wherein the input 22 is driven by the signal 18 from the microprocessor 16, and wherein the signal 18, in turn, is based on the signal 14 from the accelerometer 12. In the depicted preferred embodiment, the interface 24 may also extract regulated power from the sensor loop 26 to power itself and the other components of the device 10. Because the power to operate the device 10 may be derived from the interface itself, it requires no separate power source. In alternative embodiments, however, the use of a dedicated power supply, such as a battery or battery pack within the housing 32, is also contemplated.

The 4-20 mA output signal is sent via the control loop 26 to the control device 28, which may be any device capable of receiving a 4-20 mA control signal. The control device 28 may monitor the orientation of one or more dampers in an HVAC system. The control device 28 may also be operatively coupled to an actuator such as a motor for controlling damper position, e.g., a servo motor or stepper motor, or the like, coupled to the pivot shaft 44 of the damper 40. For example, the control device 28 may be used to rotate the damper vanes 42 until the sensed or actual position as determined by the device 10 achieves some target position. The operation of the dampers 40 by the HVAC controller 28 may be responsive to one or more temperature sensors, thermostats, user input, etc., as are generally known in the art.

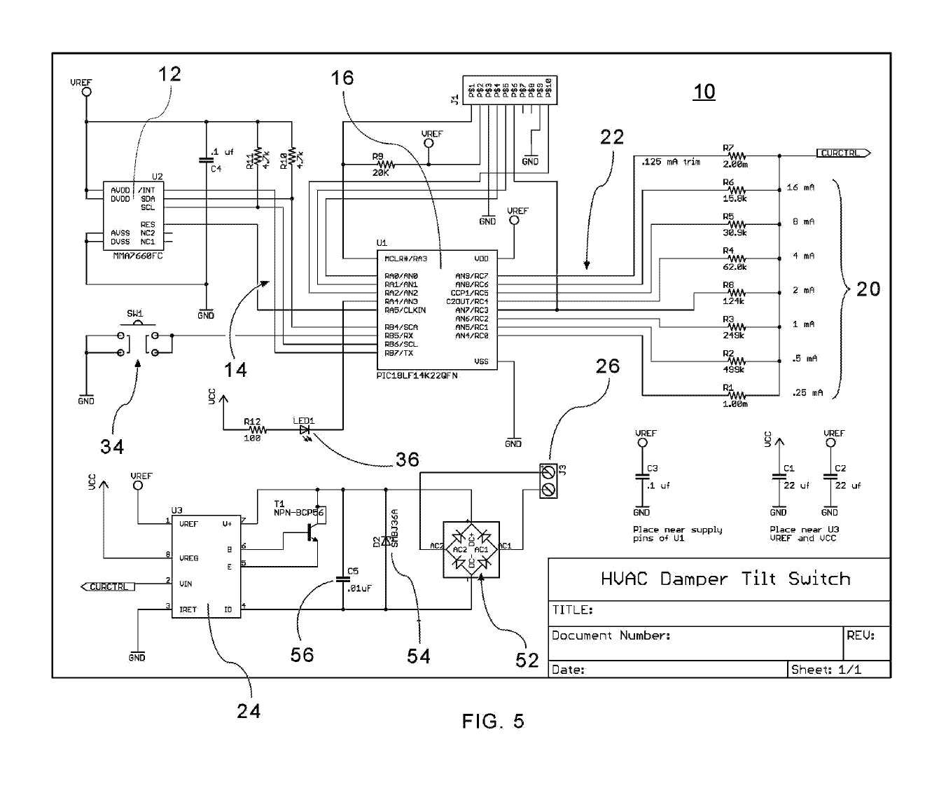

Preferably, circuit components for providing loop protection and filtering are also provided. For example, the device 10 may be protected from aberrant voltages on the sensor loop 26 with a diode bridge 52 (see FIG. 5) and a Schottky barrier 54 (see FIG. 5). The diode bridge 52 allows the loop 26 to be connected without regard to DC polarity, and the Schottky diode 54 protects the device 10 from voltages exceeding its maximum rating.

In operation, the sensor 12 outputs acceleration data to the processor 16. In the preferred embodiment, the sensor 12 is a commercially available, three-axis accelerometer having a digital output 14 using an industry-standard Serial Peripheral Interface (SPI). When connected to a processor or other compatible processing unit 16 having an SPI interface, the accelerometer 12 can receive commands from the processing unit 16 and report acceleration data.

The acceleration data is in the form of force measurements in each of three mutually orthogonal axes, usually termed “x,” “y,” and “z” (see FIG. 1). When the sensor is motionless, the Earth's gravity exerts a force on the sensor in each axis, and by reading these forces, the microprocessor can calculate the orientation of the sensor with regard to the Earth's position. This orientation can be interpreted as “tilt.”

The processor 16 may be a commercially available device capable of fetching and executing computer instructions. The processor 16 is also preferably one that also has additional peripheral functions integrated into it, including support functions necessary to operate it, a configurable clock source, a memory such as a random access memory (RAM) and read-only memory (ROM). The processor 16 also preferably contains the necessary interfaces, preferably several or many, such as an SPI or other bus that is compatible with the sensor 12. Although the accelerometer 12 and the processor 16 are depicted as discrete components, it will be recognized that the present development could also be implemented in a solid-state accelerometer which has on-chip processing, which would eliminate the need for a stand-alone processor 16. Likewise, the need for a standalone accelerometer 12 could be eliminated if a microprocessor becomes available that contains an integrated accelerometer. Similarly, a dedicated DAC 20 is shown in the preferred illustrated embodiment; however, it is contemplated that the digital-to-analog conversion could be performed by the processor 16, for example, where the processor 16 has suitable on-chip facilities or architecture for digital signal processing.

The processor 16 contains program instructions which may be referred to herein as “software” for the sake of brevity, but will be understood to also include program instructions or control logic implemented in hardware or discrete electronic components, software, firmware, or any combination thereof. The software calculates orientation from the force data output by the sensor 12 and to output a control signal 18 representative of the tilt value. The digital control signal 18 is converted to the analog current control signal 22, which is sent to the current loop interface 24. The current loop interface 24 outputs a current onto the control loop 26 within the range of 4-20 mA, with the value within the range being proportional to the angular orientation of the accelerometer 12, within a predetermined or preselected arc range of damper rotation.

In the preferred embodiment, the software or like program instructions loaded onto the processor 16 will run at periodic intervals, or more preferably as a continuous loop, to periodically monitor or sample the tilt data from the sensor 12 and report the orientation to the controller 28 as described above. Additional programming functions may also be provided, such as program instructions to increase or enhance the accuracy or stability of the accelerometer, for example, where accuracy may be compromised due to severe vibration or environmental conditions.

The current loop interface 24 communicates its state by varying the current flowing between two wires, usually between 4 and 20 mA. In the preferred embodiment, the processor 16 sets the desired output current by sending the digital control signal 18 representative of a scaled current value to the DAC 20. The scaled current value may be, for example, 1/100 of the final desired control current to be output onto the control loop 26, although other scale factors are also contemplated. In this exemplary embodiment, the control signal 18 causes the DAC to generate a 1:100 scaled current control signal 22. The loop controller 24 then amplifies the 1:100 scaled current signal 22 onto the loop 26. Thus, if the processor 16 sends a digital control signal 18 which results in a scaled current 22 which is, for example, 0.1 mA, the current loop interface 24 will then allow 10 mA to flow onto the control loop 26. The current loop interface 24 may also operate to compensate for any voltage changes, so that if the voltage varies on the loop 26, the current remains constant.

In the depicted embodiment, the device 10 generates the analog current 22 using digital outputs on the processor 16 and a simplified resistance ladder as the DAC 20. For example, by using a series of six digital outputs of the processor 16, a fixed voltage is passed through precision resistors of differing values before being connected to the current input of the loop controller 24. The resistance of each resistor is chosen such that the sum of all currents can represent any of 64 currents from 0.025 mA to 0.16 mA. A seventh resistor provides the base current of 0.04 mA. Together these can direct the controller 24 to generate the full range of 4-20 mA.

In an alternative embodiment, the DAC 20 may be implemented in a resistance ladder which receives signals on a series of eight digital outputs, wherein a fixed voltage passes through precision resistors of differing values before being connected to the current input of the loop controller 24. The resistance of each is chosen such that the sum of all currents can represent any current from 0.025 mA to 0.24 mA. Together these can direct the controller 24 to generate the full range of 4-20 mA.

Preferably, the current loop interface 24 is connected to the external loop 26 and HVAC controller 28 via a rectifier bridge 52 to protect the device 10 from inadvertent wiring errors, since either wire may be the positive or negative terminal. In addition, a Schottky diode 54 may be provided as a transient voltage suppressor to shunt dangerous voltage without damaging the device 10. A capacitor 56 may also be provided to further absorb smaller voltage spikes and suppress electrical noise present on the loop 26 before it enters the device 10. Additional components, such as a series inductor or the like, could also be provided on the loop 26 to further smooth the output.

Although the present disclosure has been described herein by way of reference to an industry standard 4-20 mA control loop, it will be recognized that sensor tilt data may be transmitted to the control device 28 via other methods, such as serial or parallel data link (e.g., RS-232), via a wireless transmission medium such as an optical (e.g., infrared) or radio frequency (RF) communication link. Furthermore, if using a 4-20 mA loop, it will be appreciated that the loop current regulator could be implemented in different ways, including with or without a microprocessor and/or DAC.

The components of the device 10 may be mounted on the circuit board 30, which in turn may be mounted within the housing or enclosure 32. In preferred embodiments, the housing is tubular and one of the axes of the accelerometer 12 (the x-axis in the depicted embodiment of FIG. 1) is aligned with or oriented parallel to the longitudinal axis 50 of the housing 32. The housing 32 may be encapsulated, for example, in epoxy or other polymeric material, or otherwise sealed or ruggedized for protection. Input and output means 34, 36 may be provided to allow an operator to configure the device 10 for a particular installation. For example, the input means 34 may be a switch, such as a momentary contact push button switch, toggle switch, a magnetic reed switch, or the like provided on the housing 32 for entering user input. The output means 36 may be a light, such as a light-emitting diode (LED) or other visual element provided on the housing to provide visual output to the user. Other input means may include a keyboard/keypad, touch screen, DIP switches, or the like. Other output means may include a display screen (e.g., an LED or LCD display); an audible or somatic output device, or the like. It will be recognized that the input and output means 34, 36 may be located at any other position on the housing, such as an end panel thereof. For example, the switch 34 and LED 36 could be provided on the housing end where the lead wires 26 exit the housing.

The two current loop interface wires 26 extend from the end of the housing 32. In the depicted embodiment, the orientation of the accelerometer 12 is preferably chosen such that the x-axis extends in a direction parallel to the axis 50 of the housing 32, and the tilt of the accelerometer 12 is presented as the inclination of the x-axis relative to the earth's surface.

As shown in the exemplary embodiment of FIGS. 2A-2C, the device 10 can advantageously be mounted to an arm 48 attached to the damper shaft 44 so that the x-axis rotates with the damper actuator shaft 44. The housing may advantageously have mounting features formed thereon for facilitating attachment to the arm 48. It will be recognized that other orientations and mounting means for attaching the device 10 to a damper may be employed.

In operation of a preferred embodiment, when power is first applied, the software in the processor unit 16 begins executing. The software first configures the processor 16 itself by configuring the SPI interface to the accelerometer 12 and sets the state of the ladder outputs 20, the switch input 34, and the LED output 36. If a user has previously configured the device for a specific angle or arc range, the configuration data is fetched from a non-volatile memory of the processor 16. Next, the software sends a series of commands to the accelerometer 12 over the SPI bus 14, to turn on the accelerometer 12 and begin periodic measurements of the force on each axis.

The software then starts its operational loop. First, force data for each axis is read from the accelerometer 12 and the pitch or inclination of the x-axis is calculated. A tracking algorithm is used to determine in which direction the shaft 44 has rotated, e.g., clockwise or counter-clockwise, e.g., by periodically monitoring and logging the pitch or inclination data, e.g., in an electronic memory of, or associated with, the processing unit 16. The magnitude and direction of rotation are applied to the absolute orientation to determine the total offset from the programmed base angle. Using this method, rotation angles of the shaft 44 greater than 360 degrees can be accurately measured, as long as the damper rotation speed does not exceed one revolution per two sensor samples.

Once the total relative rotation is calculated, the number is scaled and applied to the current loop by the device 10, as described above. If the calculated angle is below the minimum set angle, then 4 mA is output onto the interface 26. If the angle is above the maximum set angle, then 20 mA is output. If the calculated angle is between the minimum and maximum set angles, then a proportional current is output.

Periodically during operation, the software tests the switch 34 to determine if it is pressed. When the switch 34 is pressed, indicating that a user wishes to configure the device 10, the software stops its normal measurement/output loop, sets the current to 20 mA, and sets the minimum angle to the current orientation angle. It then continues to calculate angle data, while flashing the LED 34 to indicate to the operator that a configuration is in progress.

The operator then rotates the device 10 to the maximum angle, which may be clockwise or counter-clockwise, and in any magnitude from one degree to one or more full rotations. When the device 10 is in the desired position, the operator presses the switch a second time to complete the configuration. The software then turns off the LED, saves the configuration data to non-volatile memory, and resumes normal operation as described above. In alternative embodiments, the unit may be preprogrammed for a prespecified range, such as from 0-90 degrees.

The invention has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. For example, an alternative sensor may be provided with a fixed external reference point, such as an optical, magnetic, sound, or other machine readable point to allow the sensor to read its position from the external reference. It is also contemplated that a mechanical interconnect, such as an optical shaft encoder or potentiometer, may be used to attach the sensor to an external reference. It is intended that the invention be construed as including all such modifications and alterations insofar as they come within the scope of the appended claims or the equivalents thereof.

Having thus described the preferred embodiments, the invention is now claimed to be:

1. An apparatus for use in an HVAC system for measuring the position of a damper, the damper rotatable about a pivot axis to selectively resist air flow in the HVAC system, said apparatus comprising:
an accelerometer for generating acceleration data representative of an angular orientation of said accelerometer;
a signal processor which provides a position signal representative of the position of the damper in response to said acceleration data; and
a controller that is operable to output a control signal in response to said position signal to an HVAC controller.

2. The apparatus of claim 1, wherein the HVAC controller is operable to control the position of the damper.

3. The apparatus of claim 1, wherein the accelerometer is selected from the group consisting of a 2-axis accelerometer, a 3-axis accelerometer, and a digital 3-axis accelerometer.

4. The apparatus of claim 1, wherein the control signal is a current output in the range of 4-20 mA.

5. The apparatus of claim 1, further comprising:
a housing enclosing said accelerometer, said signal processor, and said controller.

6. The apparatus of claim 5, wherein said housing is selected from one or both of a sealed housing adapted to resist entry of external contaminants and a ruggedized housing adapted to withstand harsh environmental conditions.

7. The apparatus of claim 5, further comprising:
said acceleration data including force data from 2 orthogonal axes or 3 mutually orthogonal axes; and
said housing having a longitudinal axis wherein the longitudinal axis of the housing is parallel to one of said orthogonal axes.

8. The apparatus of claim 1, wherein the position signal is a digital signal, and wherein said signal processor includes a digital-to-analog converter.

9. The apparatus of claim 8, further comprising:
said position signal being a digital representation of a scaled current value, the scaled current value being a percentage of a desired current value for said control signal;
said digital-to-analog converter generating a scaled current having the scaled current value responsive to said position signal; and
said controller including an amplifier for receiving said scaled current and outputting said control signal having the desired current value.

10. The apparatus of claim 9, wherein the scaled current value is 1/100 of the desired current value.

11. The apparatus of claim 9, wherein said digital to analog converter is a resistor ladder.

12. The apparatus of claim 1, further comprising:
an input for inputting data representative of a desired range of rotation of the damper about the pivot axis; and
a memory for storing the data representative of the desired range of rotation of the damper.

13. The apparatus of claim 1, further comprising:
control logic for monitoring the position of the damper at periodic time intervals; and
a memory for logging data representative of the position of the damper over time.

14. A method for determining the position of a damper in an HVAC system, said method comprising:
providing an accelerometer;
disposing the accelerometer on the damper;
generating acceleration data with the accelerometer, the acceleration data representative of the angular orientation of the accelerometer;
creating a position signal in response to the acceleration data, the position signal representative of the position of the damper;
processing the position signal to produce a control signal indicative of the position of the damper.

15. The method of claim 14, further comprising:
adjusting the position of the damper in response to the control signal to achieve a desired position of the damper.

16. The method of claim 14, wherein the damper is rotatable about a pivot shaft and further wherein said step of disposing the accelerometer on the damper includes mounting the accelerometer to an arm extending from the pivot shaft.

17. The method of claim 14, wherein the accelerometer is selected from the group consisting of a 2-axis accelerometer, a 3-axis accelerometer, and a digital 3-axis accelerometer.

18. The method of claim 14, wherein the control signal is a current output in the range of 4-20 mA.

19. The method of claim 14, wherein the damper is rotatable about a pivot axis, said method further comprising:
inputting data representative of a desired range of rotation of the damper about the pivot axis; and
said control signal representative of a position value within said desired range of rotation.

20. The method of claim 14, further comprising:
monitoring the position of the damper at periodic time intervals; and
logging data representative of the position of the damper over time.
